(19) United States
(12) Patent Application Publication
(10) Pub. No.: US 2025/0285163 A1
(43) Pub. Date: Sep. 11, 2025

(54) INFORMATION PROCESSING DEVICE AND INFORMATION PROCESSING METHOD

(71) Applicant: TOSHIBA TEC KABUSHIKI KAISHA, Tokyo (JP)

(72) Inventors: Yuya Omiya, Ota Tokyo (JP); Takumi Ito, Ota Tokyo (JP); Yusuke Kawai, Kawasaki Kanagawa (JP); Nana Sato, Ota Tokyo (JP); Yumiko Okuma, Koganei Tokyo (JP)

(21) Appl. No.: 18/946,999

(22) Filed: Nov. 14, 2024

(30) Foreign Application Priority Data
Mar. 8, 2024 (JP) 2024-036033

(51) Int. Cl. G06Q 30/0601

(52) U.S. Cl. CPC G06Q 30/0631; G06Q 30/0641

(57) ABSTRACT

According to one embodiment, an information processing device and an information processing method that enables a suggestion of a personalized coordination idea to a customer are provided. An information processing device according to an embodiment includes: a specifying unit that specifies a customer visiting a store; an acquisition unit that acquires information about an action of the customer specified by the specifying unit; a first presentation unit that presents, to the customer, event information indicating an event correlated with the action of the customer, based on the information about the action of the customer acquired by the acquisition unit; a derivation unit that derives a merchandise item to be suggested to the customer, based on event information selected by the customer from among the event information presented by the first presentation unit; and a second presentation unit that presents the merchandise item derived by the derivation unit to the customer.

### CROSS-REFERENCE TO RELATED APPLICATION

This application is based upon and claims the benefit of priority from Japanese Patent Application No. 2024-036033, filed on Mar. 8, 2024, the entire contents of which are incorporated herein by reference.

### FIELD

Embodiments described herein relate generally to an information processing device and an information processing method.

### BACKGROUND

According to the related art, at a retail store dealing in clothing such as an apparel store, a customer service is provided by a store clerk. At such a retail store, a store clerk suggests a combination of clothes suitable for a customer (hereinafter referred to as a coordination idea), that is, a personalized coordination idea, in response to a request by the customer.

However, at a store, there are often cases where a store clerk may not be able to secure a sufficient serving time for each customer. In such cases, the store cannot suggest a personalized coordination idea to each customer, posing a problem in that the store loses sales opportunities.

### DESCRIPTION OF THE DRAWINGS

FIG. 1 is a schematic view showing a schematic configuration of a coordination idea suggestion system according to an embodiment.

FIG. 2 is a block diagram showing an example of the hardware configuration of a mirror signage.

FIG. 3 is a block diagram showing an example of the hardware configuration of a store server.

FIG. 4 shows an example of the data configuration of a customer information DB.

FIG. 5 shows an example of the data configuration of an event calendar.

FIG. 6 shows an example of the data configuration of a merchandise master.

FIG. 7 is a block diagram showing an example of the functional configuration of the mirror signage.

FIG. 8 shows an example of a screen displayed on the mirror signage.

FIG. 9 shows an example of the screen.

FIG. 10 shows an example of the screen.

FIG. 11 is a block diagram showing an example of the functional configuration of the store server.

FIG. 12 is a sequence chart showing an example of control processing of the coordination idea suggestion system.

### DETAILED DESCRIPTION

An embodiment described herein is to provide an

information processing device and an information processing method that enable a suggestion of a personalized coordination idea to the customer.

In general, according to one embodiment, an information

processing device includes: a specifying unit configured to specify a customer visiting a store; an acquisition unit configured to acquire information about an action of the customer specified by the specifying unit; a first presentation unit configured to present, to the customer, event information indicating an event correlated with the action of the customer, based on the information about the action of the customer acquired by the acquisition unit; a derivation unit configured to derive a merchandise item to be suggested to the customer, based on event information selected by the customer from among the event information presented by the first presentation unit; and a second presentation unit configured to present the merchandise item derived by the derivation unit to the customer.

An embodiment of a coordination idea suggestion system 1 will now be described with reference to the drawings. In the embodiment described below, an example where the system is applied to an apparel store selling clothing (hereinafter also referred to as the store) is described. However, this embodiment is not limiting. Also, the embodiment described below should not limit the present disclosure. Component elements in the embodiment described below include component elements which a person skilled in the art can easily think of, substantially the same component elements, and component elements in a so-called range of equivalents. Moreover, various omissions, replacements, changes, and combinations of component elements can be made without departing from the scope of the embodiment described below.

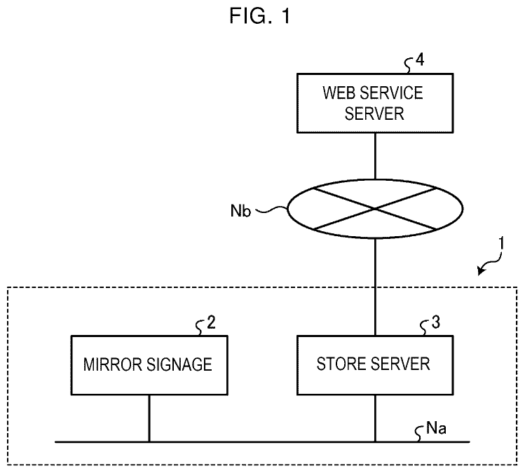

FIG. 1 is a schematic view showing a schematic configuration of the coordination idea suggestion system 1 according to the embodiment. The coordination idea suggestion system 1 has a mirror signage 2, a store server 3, and a Web service server 4.

The mirror signage 2 and the store server 3 are provided, for example, at a store or the like. The mirror signage 2 is installed, for example, in a fitting room in the store, in an aisle in the store, or the like. The store server 3 is provided, for example, at a data center or the like inside the store or outside the store.

The mirror signage 2 and the store server 3 are communicably connected to each other via a network Na such as a local area network (LAN). The store server 3 is also communicably connected to the Web service server 4 via a network Nb such as the internet. The numbers of these devices connected to the networks Na, Nb are not limited to the illustrated example.

The mirror signage 2 is an example of a display device. For example, as a half mirror is provided at a position facing a display surface of a display provided in the mirror signage 2, the mirror signage 2 reflects the appearance of a customer and also displays a display content on the display visibly to the customer. The mirror signage 2 can also be used simply as a mirror.

The mirror signage 2 displays various screens. Specifically, the mirror signage 2 displays a screen related to the customer service for the customer and a screen including an operator selectable by the customer via an operation unit 209 of the mirror signage 2. For example, the mirror signage 2 displays a screen that notifies the customer of the start f the customer service for the customer. The mirror signage 2 also displays a screen including information about an event (hereinafter referred to as an event) selectable by the customer via the operation unit 209 of the mirror signage 2. The mirror signage 2 also displays a screen including a coordination idea about merchandise items (including, for example, tops, pants, shoes, accessories, and the like; hereinafter referred to as clothing items) which the customer is recommended to purchase, or the like.

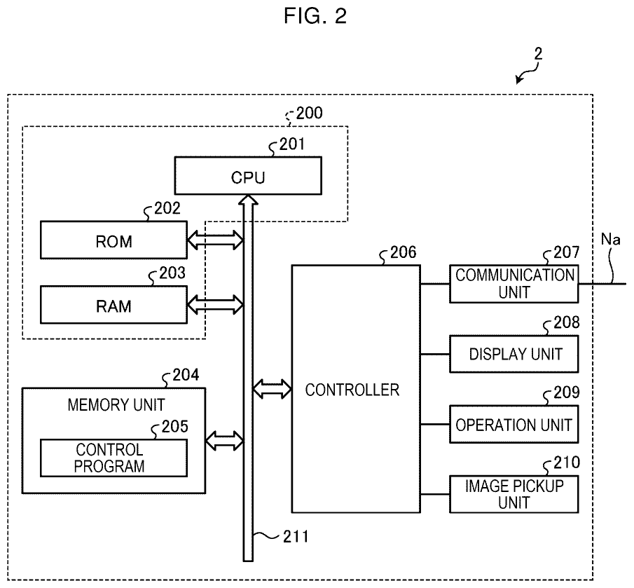

The mirror signage 2 performs authentication processing for the customer to receive a service from the store via the mirror signage 2 (hereinafter simply referred to as authentication processing), in cooperation with the store server 3, described later. Specifically, the mirror signage 2 specifies the customer, based on an image related to the specification of the customer (hereinafter also referred to as a customer image) picked up by an image pickup unit 210 (see FIG. 2) provided in the mirror signage 2, and thus performs the authentication processing. The customer image is, for example, an image of the face of the customer that is picked up.

To describe this more in detail, the mirror signage 2 transmits the customer image picked up by the image pickup unit 210 to the store server 3. Subsequently, the store server 3 extracts a feature from the received customer image and collates the extracted feature with feature data related to the specification of the customer stored in the store server 3. If the feature extracted from the customer image matches the feature data of any customer stored in the store server 3, the store server 3 transmits a notification that notifies that the authentication processing including customer information, described later, is completed normally (hereinafter also referred to as an authentication processing completion notification) to the mirror signage 2. Upon receiving the authentication processing completion notification from the store server 3, the mirror signage 2 displays a message that notifies of the customer information and the start of the customer service at a display unit 208 of the mirror signage 2. As a method for extracting a feature from the customer image, a known and available method can be employed.

For the authentication processing, various methods can be employed. For example, the image pickup unit 210 of the mirror signage 2 may read a code symbol such as a two-dimensional code provided on a store member card and thus may perform the authentication processing to specify the customer, based on a member ID or the like included in this code symbol.

The store server 3 is an example of an information processing device. The store server 3 is, for example, a server device installed in the store. The store server 3 stores the customer information of the customer, information corresponding to information about an event, information about the price or the like of a clothing item available at the store, and a program correlated with the generation of a coordination idea about clothing items to be suggested to the customer, or the like. Details of the customer information and the information corresponding to the information about the event will be described later. The store server 3 performs the authentication processing in cooperation with the mirror signage 2. The store server 3 may be configured with a plurality of computers. In other words, the functions of the store server 3 may be distributed to a plurality of computers. The store server 3 may be a cloud server installed on a cloud.

The store server 3 performs a series of processes related to the generation and provision of a sales promotion text to be suggested to the customer by a coordination idea suggestion LLM 309 stored in the store server 3, described later (hereinafter also referred to as coordination idea suggestion processing). Details of the sales promotion text and the coordination idea suggestion processing will be described later.

The Web service server 4 is, for example, a server device installed on a cloud. The Web service server 4 stores a social networking service (SNS) account of the customer, information linked to the account, information correlated with an event specific to the customer, and the like. The Web service server 4 also provides the foregoing information stored in the Web service server 4 to the store server 3 via the network Nb in response to a request by the store server 3.

The configuration of the forgoing mirror signage 2 will now be described with reference to FIG. 2. FIG. 2 is a block diagram showing an example of the hardware configuration of the mirror signage 2 according to the embodiment. As shown in FIG. 2, the mirror signage 2 has a central processing unit (CPU) 201 as an example of a processor, a read-only memory (ROM) 202, a random-access memory (RAM) 203, a memory unit 204, and the like.

The CPU 201 manages and controls each part of the mirror signage 2. The ROM 202 stores various programs. The RAM 203 is a work space where a program and various data are loaded. The memory unit 204 stores various programs.

The CPU 201, the ROM 202, the RAM 203, and the memory unit 204 are coupled to each other via a bus 211. The CPU 201, the ROM 202, and the RAM 203 form a control unit 200 with a computer configuration. That is, the control unit 200 executes control processing of the mirror signage 2, described later, by causing the CPU 201 to operate according to a control program unit 205 stored in the ROM 202 or the memory unit 204 and loaded in the RAM 203.

The memory unit 204 is a nonvolatile memory such as a hard disk drive (HDD) or a: flash memory where stored information is held even when the power is turned off. The memory unit 204 has the control program unit 205.

The control unit 200 is coupled to a communication unit 207, the display unit 208, the operation unit 209, and the image pickup unit 210 via a controller 206 and the bus 211.

The communication unit 207 is a communication interface to connect to the store server 3 via the network Na. The store server 3 also connects to the Web service server 4 via the network Nb.

The controller 206 is coupled to the communication unit 207, the display unit 208, the operation unit 209, and the image pickup unit 210. The controller 206 controls each connected unit, based on a command from the control unit 200.

The display unit 208 is a display device such as a liquid crystal display (LCD). The display unit 208 displays various information under the control of the CPU 201. The operation unit 209 is a touch panel provided at the display unit 208. The operation unit 209 outputs an operation content inputted via an input device, to the CPU 201. The operation unit 209 may be an input device such as a keyboard or a pointing device. The image pickup unit 210 is an image pickup device having an image pickup element such as a CCD or a CMOS.

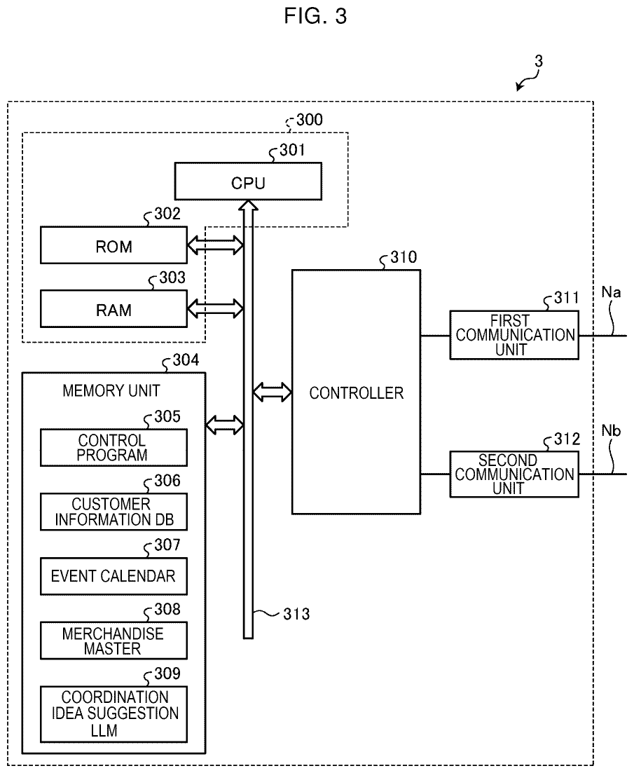

The configuration of the foregoing store server 3 will now be described with reference to FIG. 3. FIG. 3 is a block diagram showing an example of the hardware configuration of the store server 3 according to the embodiment. As shown in FIG. 3, the store server 3 has a CPU 301 as an example of a processor, a ROM 302, a RAM 303, and a memory unit 304 or the like.

The CPU 301 manages and controls each part of the store server 3. The ROM 302 stores various programs. The RAM 303 is a work space where a program and various data are loaded. The memory unit 304 stores various programs.

The CPU 301, the ROM 302, the RAM 303, and the memory unit 304 are coupled to each other via a bus 313. The CPU 301, the ROM 302, and the RAM 303 form a control unit 300 with a computer configuration. That is, the control unit 300 executes control processing of the store server 3, described later, by causing the CPU 301 to operate according to a control program unit 305 stored in the ROM 302 or the memory unit 304 and loaded in the RAM 303.

The memory unit 304 is a nonvolatile memory such as an HDD or a flash memory where stored information is held even when the power is turned off. The memory unit 304 has the control program unit 305, a customer information DB 306, an event calendar 307, a merchandise master 308, and the coordination idea suggestion LLM 309.

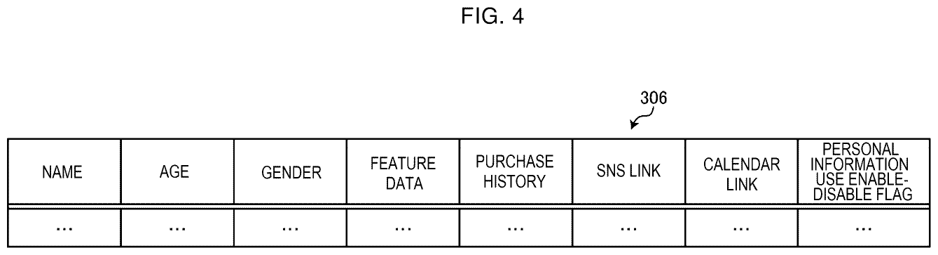

The customer information DB 306 is a data table or a database for the store to manage customer information. FIG. 4 shows an example of the data configuration of the customer information DB 306. As shown in FIG. 4, the customer information DB 306 stores customer information of customers, such as the name, age, gender, feature data, purchase history, personal information use enable-disable flag, SNS link, calendar link, and the like.

As the feature data, feature data extracted from the customer image is stored. The feature data is acquired by quantifying a feature of the customer image calculated using a known and available technique. If the member card is used for the authentication processing, the member ID or the like held on the member card may be stored as the feature data.

The purchase history is a record of purchase of merchandise items or the like, such as the date and time when the customer purchased a merchandise item at the store managing the customer information DB 306. The SNS link is a link to access information linked to an SNS account or an account of the customer. The calendar link is a link to access an external calendar service used by the customer. By accessing the calendar link, the customer can refer to or acquire a schedule registered with the customer's own calendar or event information about an event registered as a schedule. The event information is, for example, information in which the dates when various events are held, and event contents such as event names and images correlated with the events, correspond to each other.

The personal information use enable-disable flag is flag information to prescribe whether to enable the use of the personal information of the customer in coordination idea suggestion processing, described later. The personal information use enable-disable flag is, for example, binary flag information having the value “1” if the flag is enabled (hereinafter also referred to as an ON-state) and the value “0” if the flag is disabled (hereinafter also referred to as an OFF-state). Specifically, if the personal information use enable-disable flag is enabled, the control unit 300 of the store server 3 accesses a server corresponding to the address stored in the SNS link and the calendar link, that is, the Web service server 4, in the coordination idea suggestion processing. The control unit 300 of the store server 3 then acquires the personal information of the customer, that is, the information linked to the SNS account and the account of the customer and the event information about the event registered with the schedule managed by the customer, from the Web service server 4.

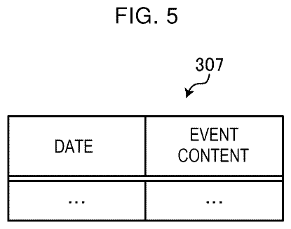

Referring back to FIG. 3, the event calendar 307 is a data table or a database for the store to manage events. FIG. 5 shows an example of the data configuration of the event calendar 307. As shown in FIG. 5, the event calendar 307 stores the event information.

The date stored in the event calendar 307 is stored, for example, in the format of “YYYY/MM/DD” representing the year, month, and date, or “MMMM D, YYYY” representing the month, day, and year. The event content stored in the event calendar 307 is, for example, a name correlated with an event or the like held at a facility installed along with the store or a facility in the neighborhood of the store, or an image correlated with the event.

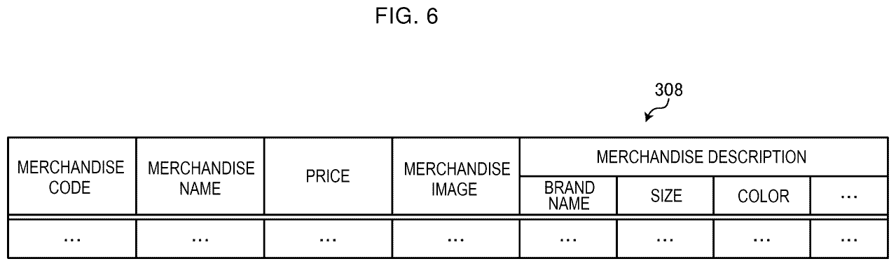

Referring back to FIG. 3, the merchandise master 308 is a data table or a database to manage the price or the like of a merchandise item available for sale at the store. FIG. 6 shows an example of the data configuration of the merchandise master 308. As shown in FIG. 6, the merchandise master 308 stores, in association with a merchandise code that can identify the type of a merchandise item available for sale at the store, merchandise information such as the merchandise name, price, merchandise image, and merchandise description of the merchandise item corresponding to the merchandise code.

The merchandise image is, for example, an image showing a merchandise item. The merchandise description stored in the merchandise master 308 includes, for example, information such as the brand name, size, color or the like of a merchandise item which is a clothing item, and the storage place of the merchandise item in the store. The merchandise description also includes information indicating a season, environment, event or the like suitable for wearing the item, and information that contributes to the decision to derive the merchandise item to be suggested to the customer.

Referring back to FIG. 3, the coordination idea suggestion LLM 309 is generative AI that generates texts, and is a large language model (LLM). The coordination idea suggestion LLM 309 is an example of generative AI that learns patterns and relations of data and thus can generate new contents such as images, sentences, voices, and structured data.

The coordination idea suggestion LLM 309 is, for example, an LLM that is constructed by a known deep learning technique and that, upon receiving an input of a text designating a condition, outputs a text about a merchandise item based on the condition. For example, the condition is a reference condition that serves as a reference for deriving an output result, or a limiting condition to narrow down an output result.

The coordination idea suggestion LLM 309 derives a coordination idea about a merchandise item available for sale at the store, based on various conditions inputted thereto, and generates a sales promotion text to promote the sales of the derived merchandise item. The sales promotion text is, for example, text data describing the merchandise name of a clothing item which the customer is recommended to purchase, the merchandise description of this clothing item, and the like. The sales promotion text may be text data in the form of a list including the names of a plurality of clothing items and the description of the plurality of the clothing items.

In this embodiment, an LLM is used as generative AI. However, the generative AI may be any generative AI that can generate a text and is not limited to an LLM. The coordination idea suggestion LLM 309 may be configured independently of the store server 3. In other words, the coordination idea suggestion LLM 309 may be installed outside the store or on a cloud and may be configured to be able to communicate in response to a request by the store server 3.

The coordination idea suggestion LLM 309 in this embodiment generates a sales promotion text for the customer in response to an input of an input sentence including the event information selected by the customer in the coordination idea suggestion processing, described later, and instruction information giving an instruction to generate a sales promotion text.

The input sentence is generated, for example, in the form of a character string described in a natural language. Specifically, the instruction information includes a character string (hereinafter referred to as a prompt) including the content, format, and information of a sentence to be generated by the coordination idea suggestion LLM 309. More preferably, the sentence described by the prompt may be, for example, a sentence that explicitly represents the event information of the event selected by the customer and that includes an instruction to generate a sales promotion text based on the event information and the customer's taste and preference about clothing items (hereinafter referred to as taste and preference information).

The method for generating the prompt is not particularly limited. For example, a generation processing unit 3003 of the store server 3, described later, may employ a method of generating the prompt, based on a predetermined template. In this case, a plurality of templates corresponding to the event information and the genders and age groups of customers may be prepared, and the generation processing unit 3003 may be configured to switch the template to use according to the event information selected by the customer or the customer information.

As an example of the prompt, for example, a prompt giving an instruction to generate a sentence including a content correlated with the age of the customer included in the customer information may be inputted to the LLM. Also, for example, a prompt giving an instruction to generate a sentence including a content correlated with a merchandise item recorded in the purchase history included in the customer information may be inputted to the LLM.

The control unit 300 is coupled to a first communication unit 311 and a second communication unit 312 via a controller 310 and the bus 313. The first communication unit 311 is a communication interface to connect to the mirror signage 2 via the network Na. The second communication unit 312 is a communication interface to connect to the Web service server 4 via the network Nb.

The controller 310 is coupled to the first communication unit 311 and the second communication unit 312. The controller 310 controls each part coupled thereto, based on a command from the control unit 300.

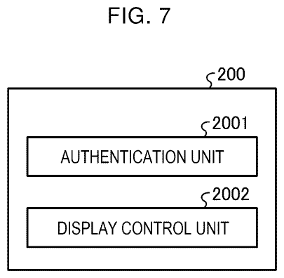

The functional configuration of the control unit 200 of the mirror signage 2 will now be described with reference to FIG. 7. FIG. 7 is a block diagram showing an example of the functional configuration of the mirror signage 2 according to the embodiment. As shown in FIG. 7, the control unit 200 has an authentication unit 2001 and a display control unit 2002, as the functional configuration thereof. However, the functional configuration of the mirror signage 2 is not limited to this.

Specifically, the control unit 200 (CPU 201) of the mirror signage 2 implements the above functional configuration by executing the control program unit 205 stored in the memory unit 204. In this embodiment, the above functional configuration is a software configuration implemented by the cooperation between the processor of the mirror signage 2 and the program. However, this is not limiting. A part or all of the functional configuration may be a hardware configuration implemented by a dedicated circuit or the like.

The authentication unit 2001 performs authentication of a customer, using the image pickup unit 210. Specifically, the authentication unit 2001 picks up a customer image via the image pickup unit 210. The authentication unit 2001 transmits the picked-up customer image to the store server 3. Upon receiving an authentication processing completion notification from the store server 3, the authentication unit 2001 cooperates with the display control unit 2002, described later, and thus causes the display unit 208 to display a message notifying of the start of the customer service. When notifying of the start of the customer service, the authentication unit 2001 may also cause the customer information to be displayed.

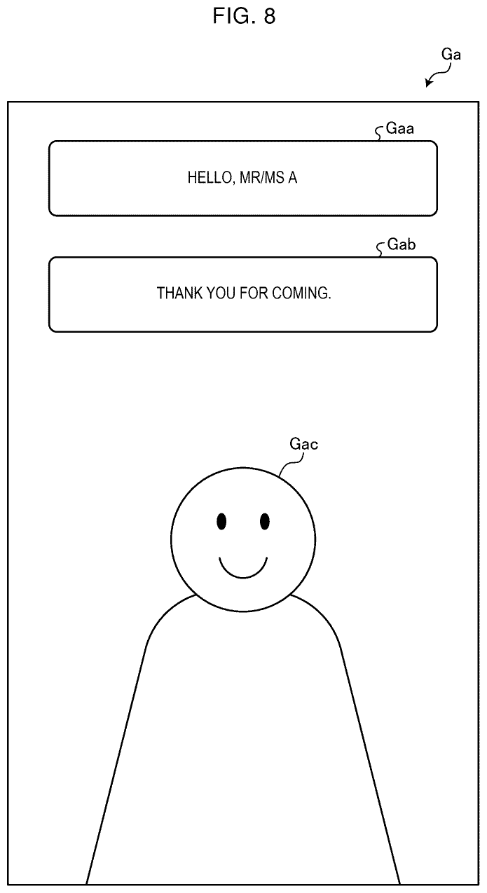

The display control unit 2002 causes the display unit 208 to display various information. Specifically, upon receiving the authentication processing completion notification from the store server 3, the display control unit 2002 causes the display unit 208 to display a message notifying of the start of the customer service as shown in FIG. 8.

FIG. 8 shows an example of the screen displayed on the mirror signage 2. The display control unit 2002 causes the display unit 208 to display a customer service start screen Ga as shown in FIG. 8 in order to notify the customer of the start of the customer service. The customer service start screen Ga includes an area Gaa where the customer information and a message related to the start of the customer service are displayed, an area Gab where a message thanking the customer for visiting the store is displayed, and an area Gac where an avatar with an image of a store clerk is displayed. Also, the display control unit 2002 may be configured not to display the customer information.

If the authentication is not completed normally, for example, if the customer performing the authentication processing is a new customer or the like and is not registered yet with the customer information DB 306, the display control unit 2002 may not cause the mirror signage 2 to display the customer service start screen Ga and may cause the mirror signage 2 to be used simply as a mirror. The display control unit 2002 may cause the mirror signage 2 to display a screen that prompts the customer to perform member registration, instead of causing the mirror signage 2 to display the customer service start screen Ga.

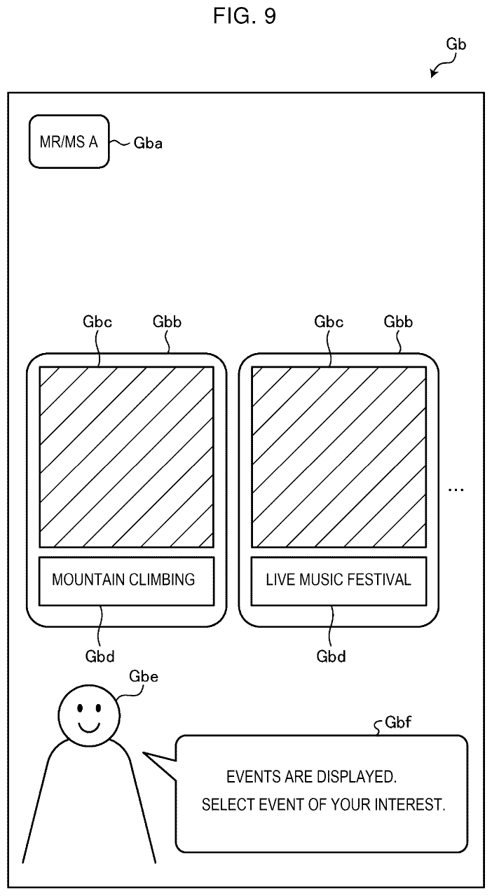

If the authentication processing is completed normally, the store server 3 transmits the event information to the mirror signage 2. Referring back to FIG. 7, upon receiving the event information from the store server 3, the display control unit 2002 causes the display unit 208 to display the event information in a selectable format via the operation unit 209, as shown in FIG. 9.

FIG. 9 shows an example of the screen displayed on the mirror signage 2. The display control unit 2002 causes the display unit 208 to display an event selection screen Gb as shown in FIG. 9, based on the event information, in order to cause the customer to select the event information of an event which the customer himself or herself is interested in. The event selection screen Gb includes an area Gba, an area Gbb, an area Gbc, and an area Gbd, an area Gbe, and an area Gbf.

In the area Gba, the name of the customer is displayed. In the area Gbb, the event information acquired from the event calendar 307 and the link destination of the calendar link of the customer information DB 306 is displayed in the coordination idea suggestion processing, described later. Specifically, the area Gbb includes the area Gbc, where an event image included in the event information is displayed, and the area Gbd, where the event name included in the event information is displayed. The area Gbb is displayed on a per acquired event information basis. FIG. 9 shows an example where two pieces of event information with the event names “mountain climbing” and “live music festival” are shown. The area Gbd also functions as an operator (operation button), and in response to an operation within the area Gbb, enables the selection of the event information in the operated area Gbb.

In the area Gbe, an avatar mimicking a store clerk is displayed. In the area Gbf, for example, a message that prompts the customer to select event information is displayed.

The number of pieces of event information displayed in one screen is not limited to the illustrated example. If the event information does not fit in one screen, the event information that is not displayed yet may be sequentially displayed in response to a scroll operation in the left-right direction. The event selection screen Gb need not be displayed in such a way as to occupy the entirety of the display unit 208 and may be displayed only in a part of the display unit 208, and the part where the event selection screen Gb is not displayed may be usable as a mirror.

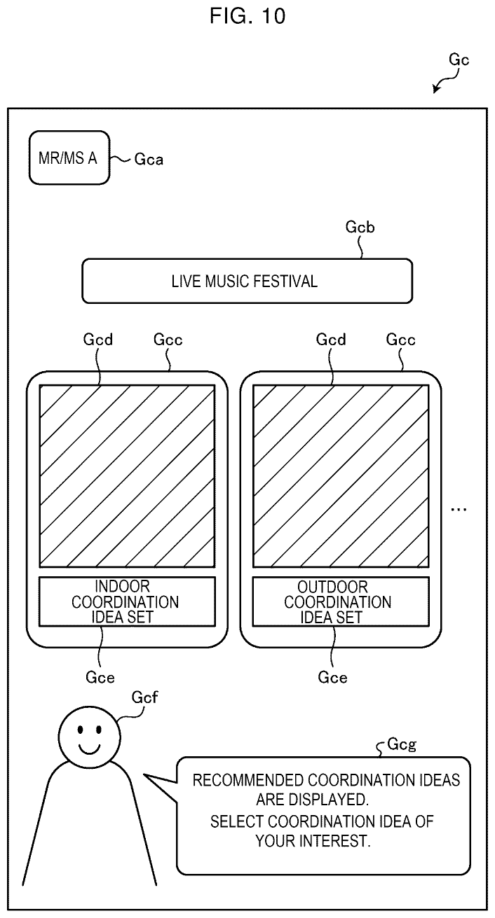

Upon accepting that one event is selected by the customer via the operation unit 209 from the event information displayed on the display unit 208 (event selection screen Gb), the display control unit 2002 transmits the selected event information to the store server 3. Also, upon receiving a coordination idea set from the store server 3, the display control unit 2002 causes the display unit 208 to display a screen that causes the customer to select the coordination idea set, as shown in FIG. 10. The coordination idea set is information including merchandise information of a plurality of merchandise items derived based on the sales promotion text generated by the coordination idea suggestion LLM 309. Specifically, in the coordination idea set, the merchandise name and a merchandise image, of each of a plurality of merchandise items derived based on the sales promotion text generated by the coordination idea suggestion LLM 309, correspond to each other.

FIG. 10 shows an example of the screen displayed on the mirror signage 2. Upon receiving a coordination idea set from the store server 3, the display control unit 2002 causes the display unit 208 to display a coordination idea selection screen Gc as shown in FIG. 10 in order to cause the customer to select the coordination idea set. The coordination idea selection screen Gc includes an area Gca, an area Gcb, an area Gcc, an area Gcd, an area Gce, an area Gcf, and an area Gcg.

In the area Gca, the name of the customer is displayed. In the area Gcb, the event name of the event selected by the customer in the event selection screen Gb is displayed. FIG. 10 shows an example where “live music festival” is selected in the event selection screen Gb. In the area Gcc, information correlated with a coordination idea set is displayed. Specifically, the area Gcc includes the area Gcd, where a merchandise image of a merchandise item included in the coordination idea set is displayed, and the area Gce, where the name of the coordination idea set corresponding to the event information is displayed. The area Gcc is displayed on a per coordination idea set basis. FIG. 10 shows an example where two coordination idea sets, that is, “indoor coordination idea set” and “outdoor coordination idea set”, corresponding to “live music festival”, which is the selected event information, are displayed. The area Gce also functions as an operator (operation button), and in response to an operation within the area Gcc, enables the selection of the coordination idea set in the operated area Gcc.

In the area Gcf, an avatar mimicking a store clerk is displayed. In the area Gcg, for example, a message that prompt the customer to select the coordination idea set is displayed.

The number of coordination idea sets displayed in one screen is not limited to the illustrated example. If the coordination idea sets do not fit in one screen, the coordination idea sets that are not displayed yet may be sequentially displayed in response to a scroll operation in the left-right direction. The coordination idea selection screen Gc need not be displayed in such a way as to occupy the entirety of the display unit 208 and may be displayed only in a part of the display unit 208, and the part where the coordination idea selection screen Gc is not displayed may be usable as a mirror.

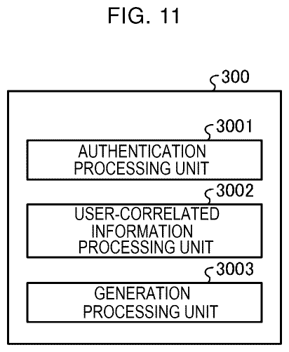

The functional configuration of the control unit 300 of the store server 3 will now be described with reference to FIG. 11. FIG. 11 is a block diagram showing an example of the functional configuration of the store server 3 according to the embodiment. As shown in FIG. 11, the control unit 300 has an authentication processing unit 3001, a user-correlated information processing unit 3002, and the generation processing unit 3003, as the functional configuration thereof. However, the functional configuration of the store server 3 is not limited to this.

Specifically, the control unit 300 (CPU 301) of the store server 3 implements the above functional configuration by executing the control program unit 305 stored in the memory unit 304. In this embodiment, the above functional configuration is a software configuration implemented by the cooperation between the processor of the store server 3 and the program. However, this is not limiting. A part of all of the functional configuration be a hardware may configuration implemented by a dedicated circuit or the like.

The authentication processing unit 3001 is an example of a specifying unit. The authentication processing unit 3001 specifies a customer visiting the store. Specifically, the authentication processing unit 3001 extracts a feature from the customer image received from the authentication unit 2001 and collates the extracted feature with feature data stored in the customer information DB 306. If the feature extracted from the customer image matches the feature data of any customer stored in the customer information DB 306, the authentication processing unit 3001 specifies that the customer corresponding to the matching feature data is visiting the store. The authentication processing unit 3001 transmits an authentication processing completion notification to the mirror signage 2.

If the authentication processing is not completed normally, that is, if the feature extracted from the customer image does not match the feature data of any customer stored in the customer information DB 306, the authentication processing unit 3001 transmits a message notifying that the authentication processing is not completed normally, to the mirror signage 2.

The user-correlated information processing unit 3002 is an example of an acquisition unit, a first presentation unit, and an extraction unit. The user-correlated information processing unit 3002 acquires information about an action of the customer specified by the authentication processing unit 3001. The information about the action is the purchase history of merchandise items purchased by the customer, posting contents posted on the SNS by the customer and an SNS user correlated with the customer, the event information of an event registered with the schedule of the customer, and the like.

Specifically, the user-correlated information processing unit 3002 accesses the SNS link of the customer stored in the customer information DB 306 and acquires the posting contents posted on the SNS by the customer and the SNS user correlated with the customer from the Web service server 4 that is the access destination, as the information about the action of the customer. The user-correlated information processing unit 3002 also accesses the calendar link of the customer stored in the customer information DB 306 and acquires the event information of the event registered with the schedule of the customer from the Web service server 4 that is the access destination, as the information about the action of the customer.

The user-correlated information processing unit 3002 accesses the Web service server 4 if the personal information use enable-disable flag of the customer stored in the customer information DB 306 is in the ON-state. The user-correlated information processing unit 3002 suppresses access to the Web service server 4 if the personal information use enable-disable flag is in the OFF-state. Hereinafter, the foregoing information acquired from the Web service server 4 is collectively referred to as user-correlated information.

The user-correlated information processing unit 3002 also extracts the taste and preference information of the customer, based on the user-correlated information acquired from the Web service server 4. Specifically, the user-correlated information processing unit 3002 extracts the taste and preference information about clothing items of the customer, based on the posting contents posted on the SNS by the customer and the SNS user correlated with the customer, acquired from the Web service server 4.

The user-correlated information processing unit 3002 presents, to the customer, the event information of the event correlated with the action of the customer, based on the information about the action of the customer acquired from the Web service server 4. Specifically, the user-correlated information processing unit 3002 uses the event information stored in the event calendar 307 and the event information of the event registered with the schedule of the customer acquired from the Web service server 4, as the event information of the event correlated with the action of the customer. The user-correlated information processing unit 3002 transmits the event information of the event correlated with the action of the customer to the mirror signage 2 and presents this information to the customer via the display unit 208.

The event information of the event correlated with the action of the customer transmitted from the user-correlated information processing unit 3002 to the mirror signage 2 may be limited to a period, for example, the event information from the present to one month ahead, or the like.

The generation processing unit 3003 is an example of a derivation unit and a second presentation unit. The generation processing unit 3003 derives a merchandise item to be suggested to the customer, based on the event information selected by the customer from among the event information presented by the user-correlated information processing unit 3002 via the display unit 208, the taste and preference information of the customer extracted by the user-correlated information processing unit 3002, and instruction information giving an instruction to suggest the merchandise item. The generation processing unit 3003 outputs the merchandise item derived by the generation processing unit 3003 in a selectable format to the customer.

Specifically, upon receiving the event information selected by the customer via the mirror signage 2, the generation processing unit 3003 generates an input sentence including this event information, the taste and preference information of the customer extracted by the user-correlated information processing unit 3002, and instruction information giving an instruction to generate sales promotion text.

The generation processing unit 3003 inputs the generated input sentence to the coordination idea suggestion LLM 309 and thus causes the coordination idea suggestion LLM 309 to generate a sales promotion text presenting a merchandise item which the customer is recommended to purchase. As the coordination idea suggestion LLM 309 generates a sales promotion text, the generation processing unit 3003 acquires the sales promotion text. Subsequently, the generation processing unit 3003 calculates the degree of similarity between the clothing item described in the sales promotion text and the merchandise items stored in the merchandise master 308, and extracts a plurality of merchandise items with a degree of similarity higher than a preset degree of similarity, from the merchandise master 308. The foregoing extracted clothing item reflects the event plan and the taste and preference of the customer.

As the method for calculating the degree of similarity between the clothing item described in the sales promotion text and the merchandise items stored in the merchandise master 308, a known and available technique may be used. For example, the degree of similarity may be calculated in the form of the matching rate of words and phrases between the description of the clothing item in the sales promotion text and the merchandise description of the merchandise items stored in the merchandise master 308. Also, for example, the merchandise description of the merchandise items stored in the merchandise master 308 may be vectorized and thus stored, using a commonly used method of natural language processing, and the degree of similarity may be calculated in the form of the degree of cosine similarity to the sentence described in the vectorized sales promotion text.

After extracting a plurality of merchandise items from the merchandise master 308, the generation processing unit 3003 generates a coordination idea set made up of a combination of the plurality of merchandise items. Subsequently, the generation processing unit 3003 transmits the generated coordination idea set to the mirror signage 2.

As the method for generating a coordination idea set,

a known and available technique may be used. For example, a coordination idea set may be generated according to a rule that defines a combining method in advance, using a factor such as a season or environment suitable for the wearing of the merchandise item stored in the merchandise description in the merchandise master 308, as a factor to decide a combination, from combinations of various types and colors of clothing items.

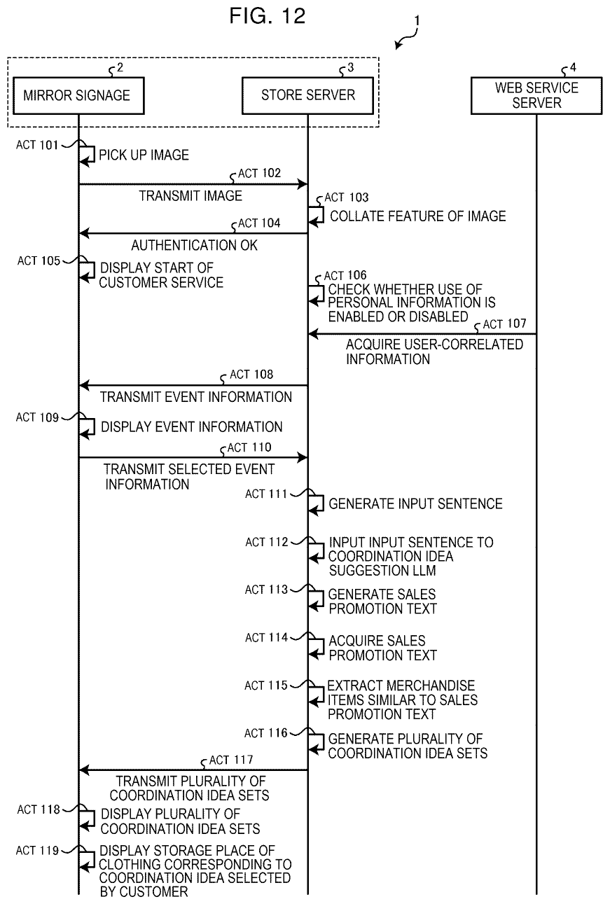

The control processing of the coordination idea suggestion system 1 will now be described with reference to FIG. 12. FIG. 12 is a sequence chart showing an example of the control processing of the coordination idea suggestion system 1 according to the embodiment. The sequence chart shown in FIG. 12 shows an example of processing in the case of performing the coordination idea suggestion processing after performing the authentication processing of a customer.

First, the authentication unit 2001 of the mirror signage 2 acquires a customer image of a customer visiting the store, via the image pickup unit 210 (ACT 101). Upon acquiring the customer image, the authentication unit 2001 transmits the acquired customer image to the store server 3 (ACT 102).

The authentication processing unit 3001 of the store server 3 extracts a feature from the customer image received from the authentication unit 2001 and collates the extracted feature with the feature data stored in the customer information DB 306 (ACT 103). If the feature extracted from the customer image matches the feature data of any customer stored in the customer information DB 306, the authentication processing unit 3001 transmits an authentication processing completion notification to the mirror signage 2 (ACT 104).

Upon receiving the authentication processing completion notification from the authentication processing unit 3001, the display control unit 2002 of the mirror signage 2 causes the display unit 208 of the mirror signage 2 to display a message notifying of the start of the customer service (ACT 105).

Meanwhile, the user-correlated information processing unit 3002 of the store server 3 determines the value of the personal information use enable-disable flag of the customer specified by the authentication processing unit 3001 from the customer information DB 306 (ACT 106). If the flag is in the ON-state, the user-correlated information processing unit 3002 accesses the SNS link of the customer stored in the customer information DB 306 and acquires the posting contents posted on the SNS by the customer and the SNS user correlated with the customer from the Web service server 4 that is the access destination. The user-correlated information processing unit 3002 then extracts the taste and preference information of the customer, based on the acquired posting contents posted on the SNS by the customer and the SNS user correlated with the customer. If the flag is in the ON-state, the user-correlated information processing unit 3002 accesses the calendar link of the customer stored in the customer information DB 306 and acquires the event information of the event registered with the schedule of the customer from the Web service server 4 that is the access destination (ACT 107).

Subsequently, the user-correlated information processing unit 3002 transmits, to the mirror signage 2, the event information stored in the event calendar 307 and the event information of the event registered with the schedule of the customer acquired from the Web service server 4 (ACT 108).

Upon receiving the event information from the user-correlated information processing unit 3002, the display control unit 2002 of the mirror signage 2 causes the display unit 208 to display the event information in a selectable format (ACT 109). Then, upon accepting a selection operation to select event information via the operation unit 209, the display control unit 2002 transmits the selected event information to the store server 3 (ACT 110).

Upon receiving the event information from the mirror signage 2, the generation processing unit 3003 of the store server 3 generates an input sentence including the received event information, the taste and preference information of the customer extracted by the user-correlated information processing unit 3002, and instruction information giving an instruction to generate a sales promotion text (ACT 111). Subsequently, the generation processing unit 3003 inputs the generated input sentence to the coordination idea suggestion LLM 309 (ACT 112) and causes the coordination idea suggestion LLM 309 to generate a sales promotion text that presents a merchandise item which the customer is recommended to purchase (ACT 113).

As the coordination idea suggestion LLM 309 generates the sales promotion text, the generation processing unit 3003 of the store server 3 acquires this sales promotion text (ACT 114). Subsequently, the generation processing unit 3003 calculates the degree of similarity between the clothing item described in the sales promotion text and the merchandise items stored in the merchandise master 308 and extracts a plurality of merchandise items with a degree of similarity higher than a predetermined degree of similarity, from the merchandise master 308 (ACT 115). Subsequently, the generation processing unit 3003 generates coordination idea sets made up of combinations of the plurality of merchandise items extracted from the merchandise master 308 (ACT 116). Subsequently, the generation processing unit 3003 transmits the generated coordination idea sets to the mirror signage 2 (ACT 117).

Upon receiving the coordination idea sets from the generation processing unit 3003, the display control unit 2002 of the mirror signage 2 causes the display unit 208 to display a screen showing the coordination idea sets (ACT 118). Then, upon accepting a selection operation to select a coordination idea set via the operation unit 209, the display control unit 2002 causes the display unit 208 to display the storage place of the clothing corresponding to the coordination idea selected by the customer (ACT 119).

If the feature extracted from the customer image does not match the feature data of any customer stored in the customer information DB 306 in ACT 104, the authentication processing unit 3001 may transmit, to the mirror signage 2, a message notifying that the authentication processing is not completed normally. Then, upon receiving the message notifying that the authentication processing is not completed normally, the display control unit 2002 may cause the display unit 208 to display this message and may return the processing to ACT 101.

Also, if the personal information use enable-disable flag of the customer specified by the authentication processing unit 3001 from the customer information DB 306 is in the OFF-state in ACT 106, the user-correlated information processing unit 3002 may acquire the merchandise information of a merchandise item for the store to recommend to the customer due to the store having a sale or the like, from the merchandise master 308, instead of acquiring the user- correlated information from the Web service server 4.

The user-correlated information processing unit 3002 may also transmit, to the mirror signage 2, a message that prompts the customer to agree to the use of the personal information. In this case, upon receiving the message from the user-correlated information processing unit 3002, the display control unit 2002 causes the display unit 208 to display the message that prompts the customer to agree to the use of the personal information, in a selectable format via the operation unit 209. If the customer agrees to the use of the personal information via the operation unit 209, the display control unit 2002 transmits, to the store server 3, a message to the effect that the customer agrees to the use of the personal information. Then, upon receiving the message, the user-correlated information processing unit 3002 changes the personal information use enable-disable flag to the ON-state and advances the processing to ACT 107.

Also, if the personal information use enable-disable flag of the customer specified by the authentication processing unit 3001 from the customer information DB 306 is in the OFF-state in ACT 106, only the event information stored in the event calendar 307 may be transmitted to the mirror signage 2 in ACT 108.

As described above, in the coordination idea suggestion system 1 according to the embodiment, the mirror signage 2 specifies a customer visiting the store in cooperation with the store server 3. The store server 3 acquires the user-correlated information of the specified customer from the

Web service server 4. The store server 3 presents event information to the customer, based on the acquired user-correlated information, in cooperation with the mirror signage 2. The store server 3 derives a merchandise item to be suggested to the customer, based on the event information selected by the customer, the user-correlated information, and instruction information giving an instruction to suggest the merchandise item. The mirror signage 2 displays the derived merchandise item to the customer.

Thus, in the coordination idea suggestion system 1 according to this embodiment, since the presentation of event information and the generation of a sales promotion text are carried out based on the information about the action of the customer, processing that reflects the characteristics of the customer can be performed. Also, based on the sales promotion text reflecting the characteristics of the customer, a coordination idea personalized for the customer can be generated. Thus, the coordination idea suggestion system 1 according to this embodiment can suggest a personalized coordination idea to the customer without human intervention.

The above embodiment can be implemented with a suitable modification by changing a part of the configurations or functions of each of the above devices. In the description below, some modification examples according to the above embodiment are described as other embodiments. In the description below, differences from the above embodiment are mainly described and the same matters as the already described contents are not described in detail. The modification examples described below may be implemented separately or may be combined where appropriate.

### Modification Example 1

In the above embodiment, in the area Gbb in the event selection screen Gb, the event information acquired from the event calendar 307 and the link destination of the calendar link of the customer information DB 306 is displayed in the coordination idea suggestion processing. However, one of the event information acquired from the event calendar 307 and the event information acquired from the link destination of the calendar link of the customer information DB 306 may be displayed in the area Gbb. For example, only the event information acquired from the event calendar 307 may be displayed in the area Gbb.

### Modification Example 2

In the above embodiment, when generating a coordination idea set, a factor such as a season or environment suitable for the wearing of the merchandise item stored in the merchandise description in the merchandise master 308 is used as a factor to decide a combination. However, this is not limiting. The taste and preference information of the customer may be used as a factor to decide a combination.

The program executed by the coordination idea suggestion system 1 according to the embodiment and the modification examples may be configured to be stored in a computer connected to a network such as the internet and then downloaded via the network and thus provided. Also, the program executed by the coordination idea suggestion system 1 according to the embodiment and the modification examples may be configured to be provided or distributed via a network such as the internet.

The program executed by each device in the above embodiment is provided in the state of being incorporated in advance in the ROM, the memory unit, or the like. The program executed by each device in the above embodiment may be configured to be recorded as a file in an installable format or an executable format in a computer-readable recording medium such as a CD-ROM, a flexible disk (FD), a CD-R, or a digital versatile disk (DVD), and provided in this state.

Also, the program executed by each device in the above embodiment may be configured to be stored in a computer connected to a network such as the internet and then downloaded via the network and thus provided. Also, the program executed by each device in the above embodiment may be configured to be provided or distributed via a network such as the internet.

While an embodiment of the present disclosure has been described, this embodiment has been presented by way of example only, and is not intended to limit the scope of the disclosure. Indeed, the novel embodiment and the modification examples thereof described herein may be embodied in a variety of other forms; furthermore, various omissions, substitutions, changes and combinations in the form of the embodiment described herein may be made without departing from the spirit of the disclosure. The accompanying claims and their equivalents are intended to cover such forms or modifications as would fall within the scope and spirit of the disclosure.

What is claimed is:

1. An information processing device, comprising:
a specifying component configured to specify a customer visiting a store;
an acquisition configured to acquire component information about an action of the customer specified by the specifying component;
a first presentation component configured to present, to the customer, event information indicating an event correlated with the action of the customer, based on the information about the action of the customer acquired by the acquisition component;
a derivation component configured to derive a merchandise item to be suggested to the customer, based on event information selected by the customer from among the event information presented by the first presentation component; and
a second presentation component configured to present the merchandise item derived by the derivation component to the customer.

2. The information processing device according to claim 1, further comprising:
an extraction component configured to extract preference information about a preference of the customer, based on the information about the action of the customer acquired by the acquisition component, wherein
the derivation component derives the merchandise item to be suggested to the customer, based on the event information and the preference information.

3. The information processing device according to claim 1, wherein
the first presentation component and the second presentation component perform a presentation via a display device configured to be operated by the customer at the store.

4. The information processing device according to claim 1, wherein
the derivation component derives a merchandise item to be suggested to the customer, from among merchandise items available for sale at the store.

5. The information processing device according to claim 3, wherein
the acquisition component includes at least one of a purchase history about merchandise items of the customer, a posting content posted on an SNS by the customer, and an event content registered with a schedule of the customer, as the information about the action of the customer.

6. The information processing device according to claim 1, wherein
the second presentation component presents the merchandise item having at least one of a same or similar brand name, size, or color with respect to a testing merchandise item the customer is in possession of.

7. The information processing device according to claim 1, wherein
the derivation component employs a generative AI model to derive the merchandise item to the customer.

8. An information processing method, comprising:
specifying a customer visiting a store;
acquiring information about an action of the specified customer;
presenting, to the customer, event information indicating an event correlated with the action of the customer, based on the acquired information about the action of the customer;
deriving a merchandise item to be suggested to the customer, based on event information selected by the customer from among the presented event information; and
presenting the derived merchandise item to the customer.

9. The information processing method according to claim 8, further comprising:
extracting preference information about a preference of the customer, based on the information about the action of the customer acquired; and
deriving the merchandise item to be suggested to the customer, based on the event information and the preference information.

10. The information processing method according to claim 8, further comprising:
performing a presentation via a display device configured to be operated by the customer at the store.

11. The information processing method according to claim 8, further comprising:
deriving a merchandise item to be suggested to the customer, from among merchandise items available for sale at the store.

12. The information processing method according to claim 10, wherein
acquiring comprises considering at least one of a purchase history about merchandise items of the customer, a posting content posted on an SNS by the customer, and an event content registered with a schedule of the customer, as the information about the action of the customer.

13. The information processing method according to claim 8, further comprising:
presenting the merchandise item having at least one of a same or similar brand name, size, or color with respect to a testing merchandise item the customer is in possession of.

14. The information processing method according to claim 8, further comprising:
employing a generative AI model derive the merchandise item to the customer.

15. A shopping assistant device, comprising:
a specifying component configured to specify a customer shopping in a store;
an acquisition component configured to acquire information about an action of the customer specified by the specifying component;
a first presentation component configured to present, to the customer, event information indicating an event correlated with the action of the customer, based on the information about the action of the customer acquired by the acquisition component;
a derivation component configured to derive a merchandise item to be suggested to the customer, based on event information selected by the customer from among the event information presented by the first presentation component; and
a second presentation component configured to present the merchandise item derived by the derivation component to the customer.

16. The shopping assistant device according to claim 15, further comprising:
an extraction component configured to extract preference information about a preference of the customer, based on the information about the action of the customer acquired by the acquisition component, wherein
the derivation component derives the merchandise item to be suggested to the customer, based on the event information and the preference information.

17. The shopping assistant device according to claim 15, wherein
the first presentation component and the second presentation component perform a presentation via a display device configured to be operated by the customer shopping at the store.

18. The shopping assistant device according to claim 15, wherein
the derivation component derives a merchandise item to be suggested to the customer, from among merchandise items available for sale at the store.

19. The shopping assistant device according to claim 17, wherein
the acquisition component includes at least one of a purchase history about merchandise items of the customer, a posting content posted on an SNS by the customer, and an event content registered with a schedule of the customer, as the information about the action of the customer.

20. The shopping assistant device according to claim 15, wherein
the second presentation component presents the merchandise item having at least one of a same or similar brand name, size, or color with respect to a testing merchandise item the customer is in possession of.
